(19) United States
(12) Patent Application Publication
(10) Pub. No.: US 2005/0041185 A1
(43) Pub. Date: Feb. 24, 2005

(54) Liquid crystal display device

(76) Inventors: Shinichiro Tanaka, Tottori-shi (JP); Satoshi Morita, Tottori-shi (JP); Takao Atarashiya, Tottori-shi (JP); Kouji Yoshida, Tottori-shi (JP)

Correspondence Address: KATTEN MUCHIN ZAVIS ROSENMAN, 525 WEST MONROE STREET, CHICAGO, IL, 60661-3693, US

(21) Appl. No.: 10/910,771

(22) Filed: Aug. 4, 2004

(30) Foreign Application Priority Data
Aug. 4, 2003 (JP) 2003-285817

(51) Int. Cl. G02F 1/1335

(52) U.S. Cl. 349/114

(57) ABSTRACT

A liquid crystal display device having a liquid crystal display panel, where a liquid crystal layer is inserted as to be sandwiched between a pair of substrates, and which is provided with polarizers on opposite sides of the liquid crystal layer with the substrates residing between the polarizers, in which a light reflecting metal layer is formed on the inner surface of the substrate on a display surface, and an λ/4 retardation film is arranged between the substrate and the polarizer to serve as light reflection preventing means for the purpose of preventing the light reflected by the metal layer from outputting from the polarizer toward the display surface even if outside light is reflected by the metal layer. According to the present invention, an inexpensive liquid crystal display device is thereby obtained, where the diminution of contrast in the display due to the reflection of outside light by a black matrix is reduced.

### BACKGROUND OF THE INVENTION

1. Field of the Invention

The present invention relates to a liquid crystal display device, particularly to a liquid crystal display device where the diminution of contrast in the display caused by the reflection of outside light by a black matrix is reduced.

2. Description of the Related Art

The use of portable communication terminals such as cell phones and PDAs has become widely spread due to recent developments in information and communication technology, leading to the expansion of the liquid crystal display device market. To meet the requirement of low power consumption, reflective liquid crystal display devices and semi-transmissive liquid crystal display devices are often utilized.

A conventional liquid crystal display device consists of a liquid crystal cell, where a liquid crystal layer is inserted between a pair of substrates having electrodes, and two polarizers arranged on both sides of the cell so as to sandwich it. The reflective type is built in such manner that a reflector is made to reside outside the polarizer on the opposite side of the observing surface of the liquid crystal cell.

However, because the incident light passes through the polarizer as many as four times before it leaves the liquid crystal display device after being reflected by the reflector, the display of the liquid crystal display device is consequently darkened, posing a problem.

For this reason, a liquid crystal display device illustrated in FIG. 6 has been proposed whereby a liquid crystal cell 52 is inserted as to be sandwiched between a polarizer 51 and a reflector 53 to allow the incident light to pass through the polarizer only twice. However, due to the insufficiency of incident light of absolute magnitude, the display of such kind of liquid crystal display device becomes dark and difficult to recognize when it is used in a dark place. Therefore, a semi-transmissive type of liquid crystal display device has been innovated, by which light from a back light is allowed to pass through windows which are provided in pixel electrodes and used when needed.

Meanwhile, the conventional liquid crystal display device has a black matrix provided between pixels and around the effective display surface, and by reflecting the outside light the black matrix glows, thereby reducing the degree of contrast in the display. The reduction is especially noticeable when the black matrix is provided at the seal portion of the display device. Contrast reduction is considerably significant in the case of the reflective type and the semi-transmissive type liquid crystal display devices which employ outside light.

A conventional black matrix generally uses a structure whereby a layer made of chromium oxide having low reflectance is formed on its side facing a glass substrate to make the side mat, and a light-shielding layer is formed thereon.

FIG. 5 shows a conventional liquid crystal display device. Thin film transistors (TFT) 31 and pixel electrodes 32, which constitute the active matrix, are formed on the upper surface of a glass substrate 33 of a TFT substrate 30. An electrode substrate 40 is provided so as to frontally face the TFT substrate 30. In the facing electrode substrate 40, a transparent electrode film 35 is formed on the bottom surface of a glass substrate 34 as a facing electrode, and light-shielding layers 36 are formed on portions corresponding to circuit elements such as the TFTs 31 residing in the TFT substrate 30. Chromium oxide thin films 39 having low reflectance are then formed at least on the surface of one side of the light-shielding layers 36, to which outside light is made to strike, and a polarizer 38 is provided on the opposite side of a liquid crystal layer 37 with the electrode substrate 40 residing between them. (As example, refer to Japanese Patent Laid-Open Publication No. 08 (1996)-95014, pages 5 to 7, FIG. 1)

However, the cost of producing chromium oxide films having low reflectance is rather high, and in addition, considering the thickness of the black matrix, producing evenly thickened liquid crystal layers is rather difficult because the chromium oxide film has a double structure in which a coating of chromium is reapplied on oxidized chromium. Consequently, an inexpensive liquid crystal display device in which the diminution of contrast in the display caused by the reflection of outside light by the black matrix is minimized, is desired.

### SUMMARY OF THE INVENTION

To address the above-described problems, the inventor of the present invention conducted various studies, and in the process, focused attention on the theory that the diminution of contrast in the display due to the reflection of outside light by the black matrix could be reduced by providing retardation (phase difference) between the incident light and output light to/from the display surface of the liquid crystal display panel. The inventor discovered that it is possible to solve the subject problems by providing a retardation film on the display surface of the facing electrode substrate without using the low reflectance chromium oxide layer on the black matrix that is formed on the facing electrode substrate of a liquid crystal display panel.

Specifically, it is the object of present invention to provide an inexpensive liquid crystal display device where the diminution of contrast in display caused by the reflection of outside light by the black matrix of a liquid crystal panel is reduced, in accordance with the following constitution.

In the liquid crystal display device of the present invention, the black matrix serving as the light shielding layer of the facing electrode substrate is composed of a chromium layer or aluminum layer intended to reflect outside light, and a retardation film is provided on the display surface of the liquid crystal display panel.

Specifically, the liquid crystal display device of the present invention is characterized by a liquid crystal display panel, wherein a liquid crystal layer is sandwiched between a pair of substrates, and is provided with polarizers on opposite sides of the liquid crystal layer with the substrates residing between the polarizers, in which a light reflecting metal layer is formed on the inner surface of the substrate on a display surface, and light reflection preventing means is arranged between the substrate on the display surface and the polarizer for the purpose of preventing the light reflected by the metal layer from outputting toward the display surface from the polarizer. As light reflection preventing means, an λ/4 retardation film or a film consisting of the combination of an λ/2 retardation film and an λ/4 retardation film can be used.

With this constitution, it is possible to obtain an inexpensive liquid crystal display device capable of blocking the reflection of outside light by the black matrix, which is made incident to the display surface and bounces back without producing the birefringence effect, by using the λ/4 retardation film as the light reflection preventing means, but it is also possible to effectively block reflected light over a wide wavelength range when a film consisting of a combination of an λ/2 retardation film and λ/4 retardation film is used. In such a case, it is preferable that the λ/2 retardation film, the λ/4 retardation film, and the facing electrode substrate be arranged under the polarizer in such order.

Further, it is preferable that in the liquid crystal display device of the present invention, a metal layer is made to reside around each pixel, and it is also preferable that the liquid crystal display device be either of the reflective or semi-transmissive type.

According to the liquid crystal display device of the present invention, the retardation film is provided as the light reflection preventing means on the display surface, which is the viewing side of the liquid crystal display panel of the facing electrode substrate, and retardation (phase difference) is generated for the incident light and the output light to/from the display surface of the liquid crystal display panel, so that it is possible to block the light reflected together with the polarizer and minimize the reduction of contrast in the display due to the reflection of outside light by the black matrix.

Furthermore, according to the liquid crystal display device of the present invention, by providing the λ/4 retardation film or the combination of λ/2 and λ/4 retardation films on the display surface, which is the viewing side of the liquid crystal display panel of the facing electrode substrate, the light reflected can be blocked together with the polarizer. In addition, a single layer of chromium or an aluminum layer can be used for the black matrix formed on the facing electrode substrate instead of the expensive low reflectance chromium oxide, making it possible to choose what type of material to use for the black matrix while producing an inexpensive liquid crystal display device.

Moreover, according to the present invention, it is possible to provide an inexpensive reflective or a semi-transmissive liquid crystal display device, where diminution of contrast in the display is minimized, exhibiting superior industrial effects.

### BRIEF DESCRIPTION OF THE DRAWINGS

FIG. 1 is a sectional view showing the constitution of a semi-transmissive liquid crystal display device of one embodiment of the present invention.

FIG. 2 is a sectional view showing the constitution of a reflective liquid crystal display device of another embodiment of the present invention.

FIG. 3 is an operational exemplary view of the present invention according to the partially enlarged view of the liquid crystal display device.

FIG. 4 is an exemplary view setting out the comparison between the reflectances in two conventional examples and the example of the present invention. FIGS. 4(a), 4(b) and 4(c) respectively show the reflectance of a conventional example 1, a conventional example 2, and the embodiment of the present invention.

FIG. 5 is a sectional view showing the constitution of a conventional liquid crystal display device.

FIG. 6 is a sectional view showing the constitution of another conventional liquid crystal display device.

### PREFERRED EMBODIMENTS OF THE INVENTION

Embodiments of the liquid crystal display device according to the present invention will be described in detail hereafter with reference to the accompanying drawings. However, while the embodiments explained below exemplify the technical concept of the present invention, they are not intended to restrict the use of the present invention to the liquid crystal display device, as they are likewise applicable to devices having a technical concept common to that of the present invention.

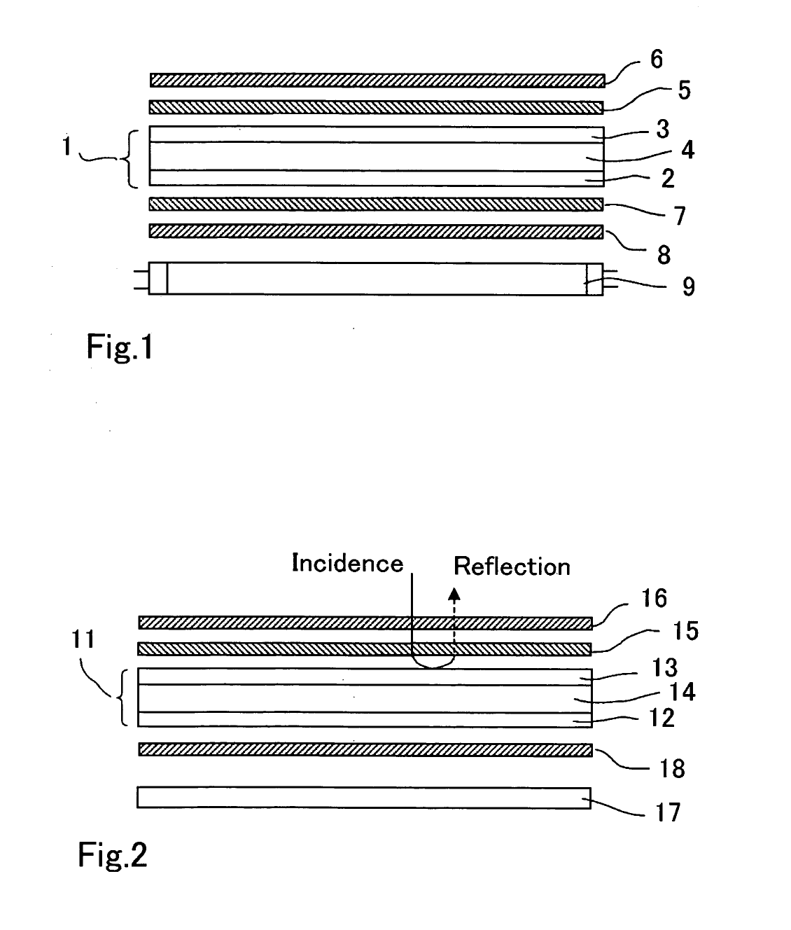

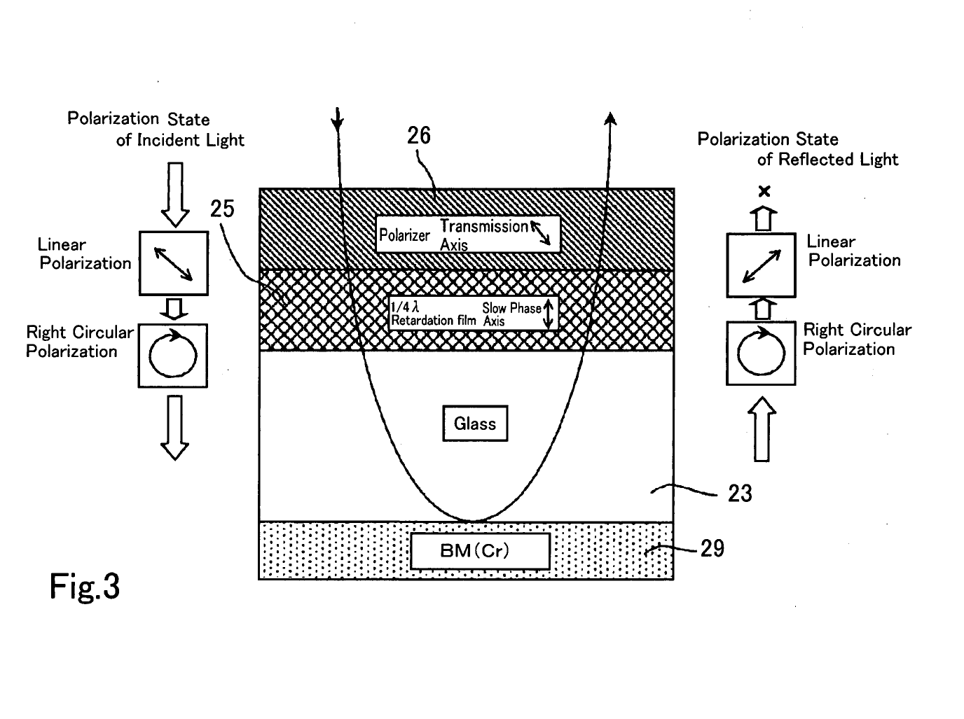

FIG. 1 is the sectional view showing the constitution of the semi-transmissive liquid crystal display device of one embodiment of the present invention. FIG. 2 is the sectional view showing the reflective liquid crystal display device of another embodiment. FIG. 3 is the exemplary view of the retardation film and the polarizer of the liquid crystal display device of the present invention in operation.

In FIG. 1, reference numeral 1 denotes the liquid crystal display panel where a liquid crystal layer 4 is confined between a pair of substrates 2, 3, and the liquid crystal layer 4 is twisted from the viewing side of the facing electrode substrate 3 toward the TFT substrate 2. Although not shown, a transparent electrode film that serves as a common facing electrode is formed on the bottom surface of the glass substrate, and a light-shielding layer is formed on portions corresponding to the circuit elements such as the thin film transistors formed on the TFT substrate 2. The light-shielding film is then made to reside around each pixel.

The light-shielding layer serving as the black matrix does not consist of a low reflectance chromium oxide layer, but is formed by spattering a single layer of metal chromium by means of the photolithography method. Reference numerals 5 and 6 denote an λ/4 retardation film made of uniaxially oriented film, which serves as the light reflection preventing means, and an upper polarizer, respectively. Reference numeral 7 denotes a light reflecting layer made of a semi-transmissive reflector. In addition, reference numerals 8 and 9 respectively denote a lower polarizer and a backlight.

According to this constitution, since the λ/4 retardation film 5 is provided on the display surface of the facing electrode substrate 3, which is the viewing side of the liquid crystal display panel 1, light reflected by the black matrix before outside light made incident to the display surface passes through the liquid crystal layer can be blocked by the λ/4 retardation film 5 and the polarizer 6. This cuts down the diminution of contrast in the display due to the reflection of outside light by the black matrix. Further, with this constitution, there is no need to use the low reflectance chromium oxide for the black matrix formed on the facing electrode substrate 3, and utilizing a single layer of metal chromium only would be sufficient. Accordingly, the structure and manufacturing of liquid crystal panels is simplified, and the cost of producing the semi-transmissive liquid crystal display device is further reduced. Furthermore, Al and the like having high reflectance can be used for the black matrix, which widens the range of options for the constitution of the metal layer.

FIG. 2 is the sectional view showing another embodiment of the reflective liquid crystal display device according to the present invention. In the drawing, reference numeral 11 denotes the liquid crystal display panel where a liquid crystal layer 14 is confined between a pair of substrates 12, 13, and the liquid crystal layer 14 is twisted from the viewing side of the facing electrode substrate 13 toward the TFT substrate 12. Although not shown, the transparent electrode film serving as the common facing electrode is formed on the bottom surface of the glass substrate, and the light-shielding layer is formed on portions corresponding to the circuit elements such as the thin film transistors formed on the TFT substrate 12. The light-shielding layer serving as the black matrix does not consist of a low reflectance chromium oxide layer, but is formed by spattering a single layer of metal chromium by means of the photolithography method. Reference numerals 15 and 16 respectively denote an λ/4 retardation film made of uniaxially oriented film, and an upper polarizer. Reference numeral 17 denotes a light-reflecting layer made from a reflecting plate. In addition, reference numeral 18 denotes a lower polarizer.

With this constitution, the λ/4 retardation film 15 is provided on the display surface of the facing electrode substrate 13 that is the viewing side of the liquid crystal display panel 11, and retardation (phase difference) is generated between the incident light and the reflected light to/from the liquid crystal display panel, so that the the outside light reflected by the black matrix and which bounces back without having the birefringence effect of liquid crystal, can be blocked by the λ/4 retardation film 15 and the polarizer 16. Thus, the curtailment of the diminution of contrast in the display generated by the reflection of outside light by the black matrix is made possible.

Further, with this constitution, there is no need to use the low reflectance chromium oxide as constitutent for the black matrix formed on the facing electrode substrate 13, and utilizing a single layer of metal chromium only would be sufficient. Accordingly, the structure and manufacturing of liquid crystal panels is simplified, and the cost of producing the reflective liquid crystal display device is further reduced.

FIG. 3 shows the operational exemplary view of the present invention. The drawing is a partially enlarged view of the liquid crystal display device, in which a polarizer 26 and an λ/4 retardation film 25 are adhered to a facing electrode substrate 23 of a liquid crystal glass panel 21 upon which a black matrix 29 is formed. The incident light passes through the polarizer 26, the λ/4 retardation film 25 and the glass, and reflects the metal chromium layer of the black matrix 29. Then, the reflected light passes through the glass, the λ/4 retardation film 25 and the polarizer 26, and reaches the viewing side.

The polarization state of the incident light during the abovementioned process is illustrated on the left side of FIG. 3, where the light is polarized in linear form by the polarizer 26, and then polarized in a circular way to the right by the λ/4 retardation film 25. The reflected light that has been polarized in a circular way to the right is then polarized in linear form by the λ/4 retardation film 25 to be orthogonal to the transmission axis of the polarizer 26 and is accordingly blocked, as drawn on the left side of FIG. 3.

Although the abovementioned refers to the example where the λ/4 retardation film is provided on the display surface of the facing electrode substrate which serves as the viewing side of the liquid crystal display panel, the λ/2 and λ/4 retardation films may likewise be provided as the light reflection preventing means on the display surface of the facing electrode substrate. This constitution possibly allows the blockage of outside light reflected by the black matrix, which bounces back by means of the λ/2 and λ/4 retardation films without having the birefringence effect of liquid crystal and the polarizer as expressed in the above-described embodiment. Furthermore, the use of λ/2 retardation film makes the transformation of the reflected light having a wide wavelength region into light polarized in linear form and blocking thereof by the polarizer possible, such that the reflected light from the metal layer is prevented from being leaked from the polarizer.

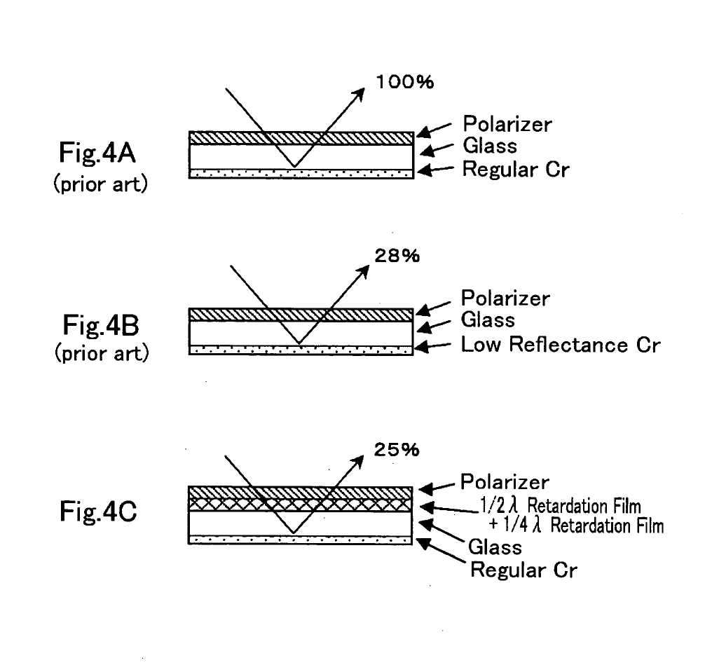

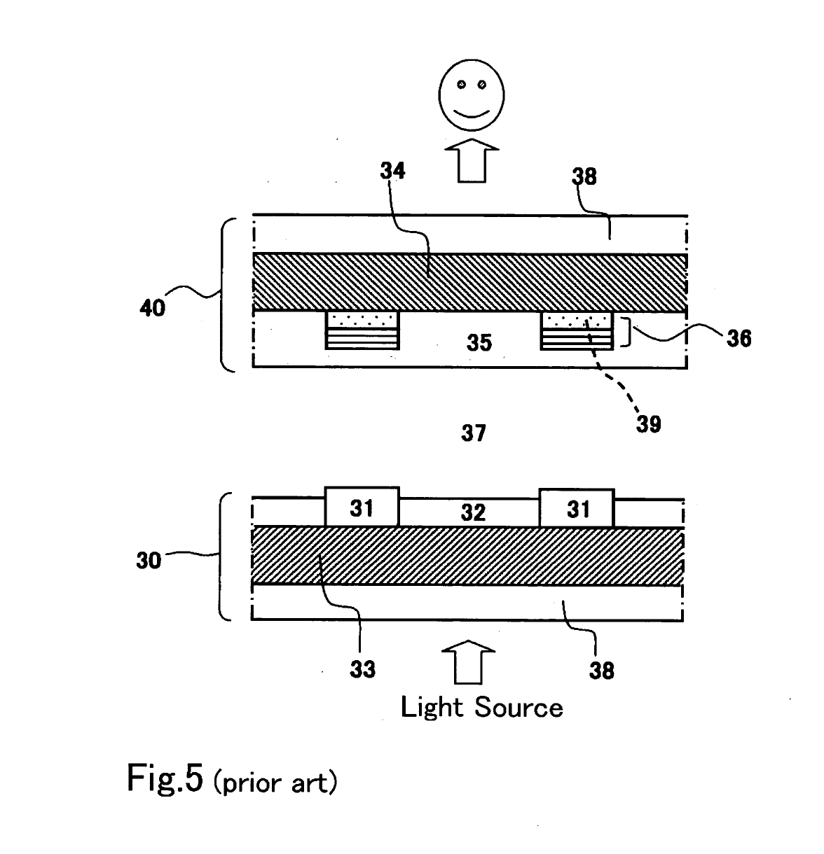

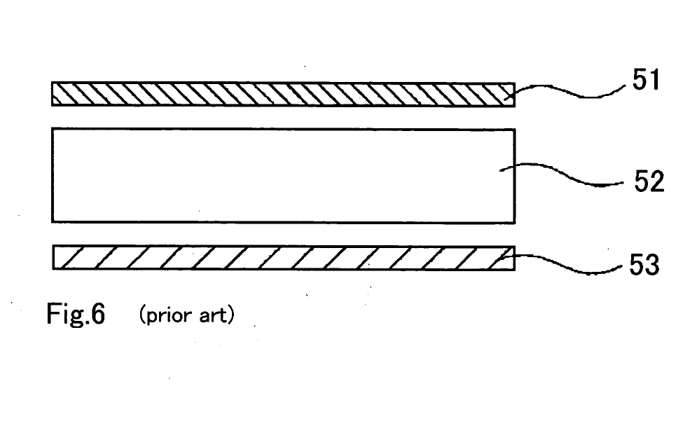

FIG. 4 shows a comparison made between conventional examples and the embodiment of the present invention. As shown in FIG. 4(a), where the polarizer, glass and the black matrix made of regular metal chromium are used, the reflectance value of the incident light in the conventional example is 100%. As shown in FIG. 4 (b), where the polarizer, glass and the black matrix using low reflectance chromium oxide are used, the reflectance value of the conventional example is 28%. In FIG. 4(c) of the embodiment, the reflectance value achieved by the use of the polarizer, the λ/2 and λ/4 retardation films, glass and the black matrix made of regular metal chromium is 25%.

As described above, the reflection of outside light is consequently blocked and sufficient contrast is obtained by the use of λ/4 retardation film even if the black matrix is made of regular metal chromium.

1. A liquid crystal display device, comprising:
a liquid crystal display panel, where a liquid crystal layer is inserted as to be sandwiched between a pair of substrates and which is provided with polarizers on opposite sides of the liquid crystal layer with the substrates residing between the polarizers,
wherein a light reflecting metal layer is formed on the inner surface of the substrate on a display surface, and light reflection preventing means for preventing the light reflected by the said metal layer from outputting from the polarizer toward the display surface is arranged between the substrate on the display surface and the polarizer.

2. The liquid crystal display device according to claim 1, wherein said metal layer resides on the periphery of each pixel.

3. The liquid crystal display device according to claim 1, wherein the said liquid crystal display device may either be a reflective liquid crystal display device or a semi-transmissive liquid crystal display device.

4. A liquid crystal display device, comprising:
a liquid crystal display panel, where a liquid crystal layer is inserted as to be sandwiched between a pair of substrates and which is provided with polarizers on opposite sides of the liquid crystal layer with the substrates residing between the polarizers,
wherein a light reflecting metal layer is formed on the inner surface of the substrate on a display surface, and light reflection preventing means for preventing the light reflected by the said metal layer from outputting from the polarizer toward the display surface is arranged between the substrate on the display surface and the polarizer, and an λ/4 retardation film serving as the light reflection preventing means is arranged between the substrate on the display surface and the polarizer.

5. The liquid crystal display device according to claim 4, wherein the said metal layer resides on the periphery of each pixel.

6. The liquid crystal display device according to claim 4, wherein the said liquid crystal display device is either a reflective liquid crystal display device or a semi-transmissive liquid crystal display device.

7. A liquid crystal display device, comprising:
a liquid crystal display panel, where a liquid crystal layer is inserted as to be sandwiched between a pair of substrates and which is provided with polarizers on opposite sides of the liquid crystal layer with the substrates residing between the polarizers,
wherein a light reflecting metal layer is formed on the inner surface of the substrate on a display surface, and light reflection preventing means for preventing the light reflected by the said metal layer from outputting from the polarizer toward the display surface is arranged between the substrate on the display surface and the polarizer, and an λ/2 retardation film and an λ/4 retardation film serving as light reflection preventing means are arranged between the substrate on the display surface and the polarizer.

8. The liquid crystal display device according to claim 7, wherein the said metal layer resides on the periphery of each pixel.

9. The liquid crystal display device according to claim 7, wherein the said liquid crystal display device is either a reflective liquid crystal display device or a semi-transmissive liquid crystal display device.
